(19) United States
(12) Patent Application Publication
(10) Pub. No.: US 2024/0051641 A1
(43) Pub. Date: Feb. 15, 2024

(54) Holding Device for an Electrical Energy Store Integrated into the Frame Tube of an Electric Bicycle

(71) Applicant: Robert Bosch GmbH, Stuttgart (DE)

(72) Inventors: Dennis Mehlo, Taichung City (TW); Lei Chen, Taichung City (TW); Thilo Koeder, Gerlingen (DE); Thorsten Droigk, Tuebingen (DE); Vikram Anil Godbole, Echterdingen (DE)

(21) Appl. No.: 18/366,144

(22) Filed: Aug. 7, 2023

(30) Foreign Application Priority Data
Aug. 10, 2022 (DE) 10 2022 208 328.8

(51) Int. Cl. B62M 6/90; B62M 6/55; B62J 43/28; B62J 43/13

(52) U.S. Cl. CPC B62M 6/90; B62M 6/55; B62J 43/28; B62J 43/13

(57) ABSTRACT

An electric bicycle includes an electric drive, at least one frame tube having an interior, an electrical energy store arranged in the interior of the frame tube, and a holding device configured to establish a connection between the electrical energy store and the frame tube. The frame tube in the interior has a receiving portion for receiving the electrical energy store. The holding device is configured to fix the electrical energy store in the interior to the frame tube and has no electrical contacts. Additionally, the holding device fixes the electrical energy store in the frame tube at least by a radial force, and the holding device is connected to the electrical energy store without a screw connection.

This application claims priority under 35 U.S.C. § 119 to application no. DE 10 2022 208 328.8, filed on Aug. 10, 2022 in Germany, the disclosure of which is incorporated herein by reference in its entirety.

### BACKGROUND

The disclosure relates to a holding device that establishes a connection between an electrical energy store and the frame tube of an electric bicycle. The electrical energy store is located in the interior of the frame tube, which is closed on the outside.

Electric bicycles are becoming increasingly popular. There is a need to accommodate the electrical energy store on the electric bicycle. To this end, three possible embodiments have established themselves in the market. The electrical energy store may be installed either on the luggage carrier, on the frame tube, or in the frame tube (intube). The intube design is very popular, since the electrical energy store can be integrated discretely into the upper tube, the lower tube, or the seat tube. The electrical energy stores can be either fixedly or releasably connected to the frame tube and typically possess, in addition to a metal jacket comprising the active components of the electrical energy store, an additional hard housing made of steel, aluminum, or hard plastic. The electrical energy store is connected by means of its housing and screws to the frame tube of the electric bicycle. The need for an additional housing disadvantageously results in a higher weight of the electrical energy store. The screw connection places increased demands on the interface and its tolerances. Holes for screwed connections in the frame tube further result in reduced stiffness and additional weight due to additional stiffening elements. Here, an electrical contact is already integrated into the holding device of the electrical energy store. This results in an additional production effort. Furthermore, in the event of damage or aging, this cannot be replaced independently of the holding device.

It would be desirable to have a holding device that, in combination with the electrical energy store, allows the weight of the electric bicycle to be lowered and is inexpensive at the same time.

### SUMMARY

In contrast, the electric bicycle described herein has the advantage of a weight-optimized and cost-optimized holding device, which fixes an electrical energy store to the frame tube. This is achieved by an electric bicycle having an electric drive. The electric bicycle has at least one frame tube having an interior and an electrical energy store. In the interior of the frame tube, in a receiving portion provided for the receptacle, the electrical energy store is connected to the frame tube by a holding device and fixed in the frame tube. In this case, the holding device comprises no electrical contacts. Furthermore, the holding device exerts at least a radial force on the electrical energy store, thereby fixing it. The holding device is, further, connected to the electrical energy store without a screw connection.

For example, in the case of a diamond frame, the upper tube, the seat tube, and/or the lower tube can be used as the frame tube for receiving the electrical energy store. Preferably, the electrical energy store is placed in the lower tube, since its interior has the largest volume. The electrical energy store may also be installed in several different frame tubes. For frame shapes other than a diamond frame, the electrical energy store may be placed in the interior of any other frame tube. Because the holding device comprises no electrical contacts, the holding device can be manufactured inexpensively. In the event of wear or signs of aging, the holding device may be repaired independently of electrical contacts. In addition to the radial force exerted by the holding device on the electrical energy store, the holding device may also exert axial holding forces on the electrical energy store. Because the holding device is connected to the electrical energy store without screwed connections, the need for additional components and installation steps is eliminated. Furthermore, the electrical energy store requires no additional receptacle for the screw connection.

The electrical energy store of the electric bicycle may also, advantageously, be embodied without additional housing, which can reduce the weight and cost of the electrical energy store. In this case, by additional housing is meant, in particular, statically-supporting hard housings made of steel, aluminum, or hard plastic, which fix battery cells of this electrical energy store and can have additional connection interfaces. Not to be understood as additional housing is the sheathing of the electrochemically-active components of the electrical energy store, as well as wrappings, which exclusively provide for fixation of the individual cells of the electrical energy store.

In an advantageous refinement of the electric bicycle, the holding device is connected to the frame tube without screw connections. Screw connections entail increased effort for the creation of the bore as well as the threads and lead to a high installation cost. Furthermore, bores in the frame tube reduce its rigidity and mechanical load capacity. These are often balanced with additional stiffeners, which, however, increase the frame weight and manufacturing costs.

In a further advantageous embodiment of the electric bicycle, the holding device has an elastic element, which attenuates the transmission of force between the frame tube and the electrical energy store and compensates for manufacturing tolerances. The elastic element is in this case situated between the electrical energy store and the frame tube. Here, the elastic element is preferably in direct contact with the electrical energy store. The elastic element comprises a flexible structure and/or an elastic material—preferably an elastomer. The tolerance compensation is effected by the material elastically yielding to different shape and position tolerances of the electrical energy store, the holding device, and the frame tube.

In another advantageous embodiment of the electric bicycle, the holding device is configured such that cables that run in the interior of the frame tube are fixed. This may prevent noises caused by loose cables that strike the frame tube due to vibrations.

As a further advantageous refinement, the electric bicycle in the interior of the frame tube comprises an axial and/or radial stop. This supports the holding device during fixation of the electrical energy store. By blocking the direction of movement of the electrical energy store in axial and/or radial directions, the stop can ensure that fewer holding elements are required for the fixation. The stop may also support the holding device during installation.

A possible preferred embodiment of such a holding device comprises a hardenable foam, which is sprayed through openings in the frame tube into a cavity between the electrical energy store and the frame tube. The hardened foam exerts at least a radial force on the electrical energy store and fixes it in the interior of the frame tube. The holding device of hardenable foam allows for simple and cost-efficient fixation of the electrical energy store in the frame tube. Cables or electrical conductors in the frame tube can also be easily fixed by the hardenable foam. A wide contact area between electrical energy store, hardenable foam, and frame tube, comprising, for example, 10% of an axial length of the electrical energy store, leads to low voltage spikes. The foam conforms to the shape of the electrical energy store, which is why it requires no additional housing.

A further preferred embodiment of the holding device can be effected by at least two toroidal hoses, which, in the installed state, are filled with a pressurized gas and receive the electrical energy store in the inner diameter of the toroidal hoses and push against the frame tube with the outer diameter of the toroidal hoses. The interiors of the hoses are connected to each other by a compensation channel. Before installation, the hoses can be placed loosely around the electrical energy store and then inserted with it into the frame tube. Alternatively, the hoses may be pre-installed in the frame tube. After the electrical energy store and the holding device are in the receiving portion, the toroidal hoses are filled with a gas via a valve, whereupon the pressure in the interior of the toroidal hoses increases and expands, fixing the electrical energy store in the frame tube. In order to further ensure fixation in case of a hole in the hose, the hoses can be provided with a sealant, which can seal holes. The structure of the holding device adapts to the shape of the electrical energy store and can compensate for manufacturing tolerances of the electrical energy store or frame tube. The hoses may also fix cables and electrical leads in the interior of the frame tube. By lowering the pressure in the hoses via the valve, the electrical energy store may be removed.

In a further advantageous embodiment, the electrical energy store, with the aid of an elastic elastomer ring surrounding it, is retained in the frame tube. To axially fix the electrical energy store, the elastomer ring sits in a groove in the frame tube and/or in the electrical energy store. The inner diameter of the elastomer ring is preferably less than or equal to the outer diameter of the electrical energy store device or its groove. Furthermore, the outer diameter of the elastomer ring, when installed on the electrical energy store, is greater than or equal to the inner diameter of the frame tube or the groove therein. Due to the resulting oversize fit, the elastomer ring must be radially compressed for installation, such that it exerts a radial force on the electrical energy store and the frame tube. The ring may be round or even bent to better conform to the shape of the electrical energy store or the inner tube. Furthermore, the ring may have a uniform thickness over the circumference or may vary in thickness. The connection via the elastomer ring may be designed to be airtight and watertight.

A further advantageous electric bicycle includes a holding device having a spring element for fixing the electrical energy store in the frame tube. The spring element may comprise springs from the group of disc springs and/or leaf springs. The spring element is attached to the electrical energy store and fixes it in the installed state—for example, via a notch in the frame tube. Alternatively, the spring element is attached to the inside of the frame tube and fixed thereto—for example, via a notch in the electrical energy store. Furthermore, the spring element, in both the frame tube and the electrical energy store, can be releasably fixed in a notch. The holding device may comprise several individual or contiguous spring elements.

Further preferably, the holding device comprises adhesive elements. The adhesive element comprises a first adhesive holding surface for contact with the electrical energy store and a second adhesive retaining surface for contact with the inside of the frame tube. Between the retaining surfaces, there is preferably an elastic carrier material having the thickness of the cavity between the electrical energy store and the frame tube. The adhesive element is preferably strip-shaped. Several adhesive elements may fix the electrical energy store on the circumference. Also contemplated is a one-sided radial fixation with a radial stop or other holding device on the opposite side of the adhesive element. Another possible embodiment of the adhesive element comprises a release strip, which is placed between the retaining surface and the carrier material and has a protruding tab. In the installed state, the adhesive element can be released by axially pulling the tab.

In a further advantageous embodiment, the electrical energy store is enclosed by a clamp or clip, which is connected to the frame tube via a connecting means. The clamp may have an elastic element and may be pre-installed in the frame tube or inserted into the frame tube with the electrical energy store. There are a variety of ways to connect the clamp to the frame tube via the connecting means. The connection can be effected by a positive, force, or material fit, e.g., through a hole in the frame tube, a thread in the connecting means and nuts, or a snap mechanism for attaching from outside.

A further preferred embodiment of the holding device comprises at least three retaining elements distributed radially over the circumference of the electrical energy store, which exert a radial force on the electrical energy store via a retaining surface. The radially outer side of the retaining element is connected to the frame tube via a connecting means. The material of the retaining element on the retaining surface is preferably elastic. The retaining element may be secured from the outside by a hole in the frame tube.

A further advantageous electric bicycle comprises a holding device having an expansion element for fixing the electrical energy store in the frame tube. The expansion element is located at the axial end of the electrical energy store and comprises at least one conical element and a deformable expansion sleeve. A screw pulls the two elements together, whereby the deformable expansion sleeve exerts a force on the frame tube. At least one of the aforementioned elements is connected to the electrical energy store. Cables in the frame tube can be guided axially through holes in the expansion element.

A further embodiment of the expansion element comprises a retaining element that resembles an expansion dowel. It comprises an axial conical bore in the center of the expansion element with a bore diameter which is somewhat larger at the beginning of the bore than the diameter of the electrical energy store and somewhat smaller at the end of the bore than the diameter of the electrical energy store. The expansion element is longer than or of the same length as the electrical energy store. The dowel-shaped expansion element is introduced into the frame tube and fixed axially there before the electrical energy store is installed. When introducing the electrical energy store unit into the frame tube, the former is pressed into the conical bore, whereby the dowel-shaped expansion element radially widens and is pressed against the frame tube via retaining surfaces.

A further possible embodiment of the holding device comprises a tapered press fit. In this case, the electrical energy store likewise comprises an inner part of the tapered press fit, which is annular or a segment of a ring, with an angled, outwardly-directed surface. The frame tube comprises an outer part belonging thereto which is also annular or a segment of a ring, with an angled, inwardly-directed surface. The angles of the inner and outer parts are arranged opposite to one another and pointing radially outwards, towards the center point of the electrical energy store. The slope of the angled surfaces is preferably the same for the inner and outer parts of the tapered press connection. The cones may be clamped together by a single axial force during installation. In a further possible embodiment, the cones are axially clamped and secured together via a screw.

As a further advantageous refinement, the holding device of the electric bicycle comprises a magnetic portion. This exerts a magnetic force upon a ferromagnetic element belonging thereto. The magnetic portion may either be placed on the electrical energy store, with the ferromagnetic element on the frame tube, or the magnetic portion is placed on the frame tube, with the ferromagnetic element on the electrical energy store. The magnetic holding device may be placed at the radial or axial end of the electrical energy store. The magnetic portion is preferably permanent-magnetic. In a further embodiment, the magnetic portion is located both on the electrical energy store and on the opposite side of the frame tube.

Another preferred embodiment of the holding device comprises a snap hook, which fixes the electrical energy store in the frame tube of the electric bicycle. The snap hook of the snap connection can in this case be connected to the frame tube, the jacket of the electrical energy store, and/or the end plate of the electrical energy store and connect to a fixing element on the opposite side. The snap hook includes an elastic web and a chamfer on the outer end to allow it to penetrate into the undercut of a fixing element. By manually bending the snap hook, it may be possible to remove the electrical energy store without destroying it.

Preferably, the holding device comprises several different retaining elements of the embodiments described above. For example, it is thus possible to fix one side of the electrical energy store with hardenable foam and the other side with an adhesive element. The retaining elements are preferably placed on both axial ends of the electrical energy store. However, it is also possible to place two or more elements alongside the electrical energy store.

As a further advantageous refinement, the electric bicycle includes an electrical conductor connecting the electrical energy store to the electric drive of the electric bicycle and/or to a cycling computer and/or to other control units or electrical consumers of the electric bicycle. The contact is effected out independently of the holding device.

The frame tube of the electric bicycle is preferably completely closed circumferentially. A frame tube with a radial opening, which can be closed, in the receiving region is also possible.

### BRIEF DESCRIPTION OF THE DRAWINGS

Exemplary embodiments of the disclosure are described in detail below with reference to the accompanying drawing. The drawings show:

FIG. 1 a schematic illustration of an electric bicycle with a sectional view of the electrical energy store and the holding device in the lower tube.

FIG. 2a a schematic sectional view of a first exemplary embodiment with a holding device of hardenable foam.

FIG. 2b a schematic section of FIG. 2 perpendicular to the longitudinal axis of the lower tube.

FIG. 3 a schematic sectional view of a second exemplary embodiment with a holding device comprising toroidal hoses.

FIG. 4a a schematic sectional view of a third exemplary embodiment with a holding device of elastomer rings in a groove in the electrical energy store or the frame tube.

FIG. 4b a schematic sectional view of a variation of the third exemplary embodiment with a holding device of elastomer rings in a groove in the electrical energy store and the frame tube.

FIG. 5 a schematic sectional view of a fourth exemplary embodiment with a holding device comprising spring elements.

FIG. 6 a schematic sectional view of a fifth exemplary embodiment with a holding device comprising adhesive elements and a radial stop.

FIG. 7 a schematic sectional view of a sixth exemplary embodiment with a holding device comprising two clamps.

FIG. 8 a schematic sectional view of a seventh exemplary embodiment with a holding device comprising retaining elements, fixed from the outside in the frame tube, and an axial stop.

FIG. 9 a schematic sectional view of an eighth exemplary embodiment with a holding device comprising multi-part expansion elements.

FIG. 10 a schematic sectional view of a ninth exemplary embodiment with a holding device comprising a one-piece expansion element.

FIG. 11 a schematic sectional view of a tenth exemplary embodiment with a holding device comprising a tapered press fit.

FIG. 12 a schematic sectional view of an eleventh exemplary embodiment with a holding device comprising a magnetic portion.

FIG. 13 a schematic sectional view of a twelfth exemplary embodiment with a holding device comprising a snap connection.

FIG. 14 a schematic sectional view of a combination of two different holding devices.

### DETAILED DESCRIPTION

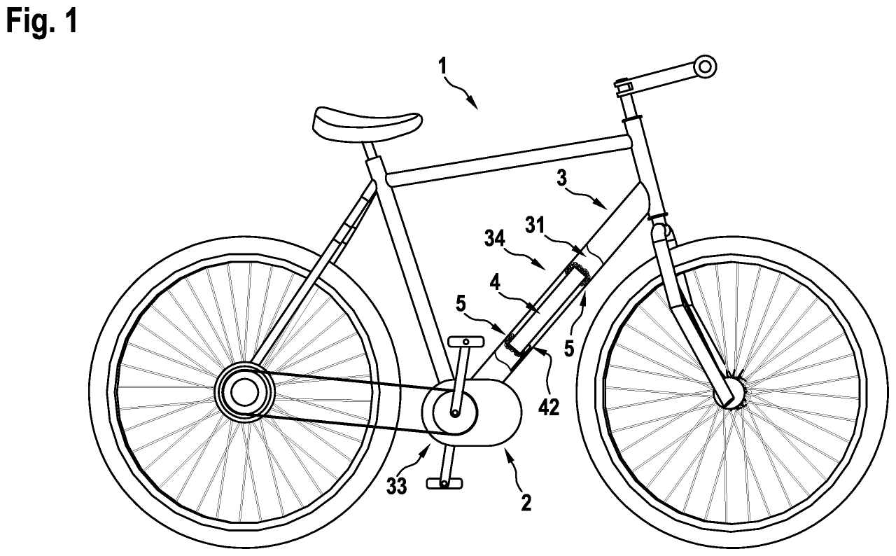

With reference to FIGS. 1 through 14, exemplary embodiments of the disclosure are described in detail below. Like and equivalent as well as like or equivalently acting elements and components are denoted by the same reference signs. Detailed description of the designated elements and components is not repeated in every case of their occurrence.

The illustrated features and other properties may be isolated from one another in any form and may be combined as desired, without departing from the core of the disclosure.

First, with reference to FIG. 1, an electric bicycle 1 in an embodiment preferred according to the present disclosure will, by way of example, be described in detail. The electric bicycle comprises an electric drive 2. This can be installed on the bottom bracket, as shown in FIG. 1. It may also be installed in the rear wheel hub and/or front wheel hub.

Furthermore, the electric bicycle 1 comprises a frame tube 3, which may be part of any frame shape. FIG. 1 shows an electric bicycle 1 with a diamond frame shape comprising a lower tube, an upper tube, and a seat tube. The frame tube is hollow and comprises an interior 31. In at least one interior 31 of the electric bicycle, there is a receiving portion 34 for receiving an electrical energy store 4.

The electrical energy store 4 is placed therein through an opening 33 in the frame tube 3. The opening in the frame tube may be located at an axial end of the frame tube, as in FIG. 1, for example, in the bottom bracket region. Alternatively, it is conceivable to introduce the electrical energy store 4 into the frame through an opening 33, which is located in the lateral surface, in the frame tube 3.

The electrical energy store 4 is fixed via a holding device 5 in the receiving portion 34 of the frame tube 3. An electrical conductor 42 connects the electrical energy store 4 to the electrical drive 2 and/or a cycling computer and/or electrical consumer of the electric bicycle and/or other control units.

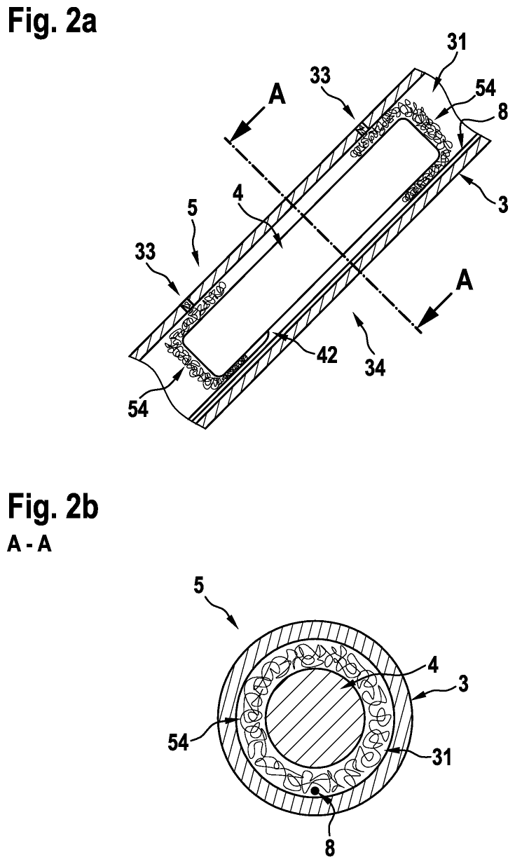

FIGS. 2a through 14 schematically show exemplary embodiments of the holding device. They show a cutout of the electric bicycle 1 with a section through the frame tube 3 in the area of the receiving portion 34. The electrical energy store 4, the holding device 5, as well as the electrical conductor 42, inter alia, can be seen in the section.

FIG. 2a schematically shows, according to a first exemplary embodiment, in a section parallel to the longitudinal axis of the frame tube 3, a holding device which uses hardenable foam 54 for fixing the electrical energy store 4. This is brought through openings 33 in the frame tube 3 in liquid form into the intermediate space between the frame tube 3 and the electrical energy store 4. Through the expansion of the hardenable foam 54 upon curing, it exerts at least a radial force upon the electrical energy store and fixes it. Preferably, the hardenable foam 54 is attached to the ends of the electrical energy store 4. When the hardenable foam 54 encloses an end of the electrical energy store 4, it also serves as an axial stop. The hardenable foam 54 may fix cables 8 or electrical conductors 42 in the interior 31 of the frame tube 3 so that they do not generate noise due to vibrations.

A section A—A perpendicular to the longitudinal axis of the frame tube is shown schematically in FIG. 2b. It shows, for example, a circular cross-section of the frame tube 3, of the electrical energy store 4, and of the cable 8. The cross-sections of the aforementioned objects may also have different, non-circular, cross-sections. In the background of the section between electrical energy store 4 and frame tube 3, the hardenable foam 54 can be seen as the holding device 5.

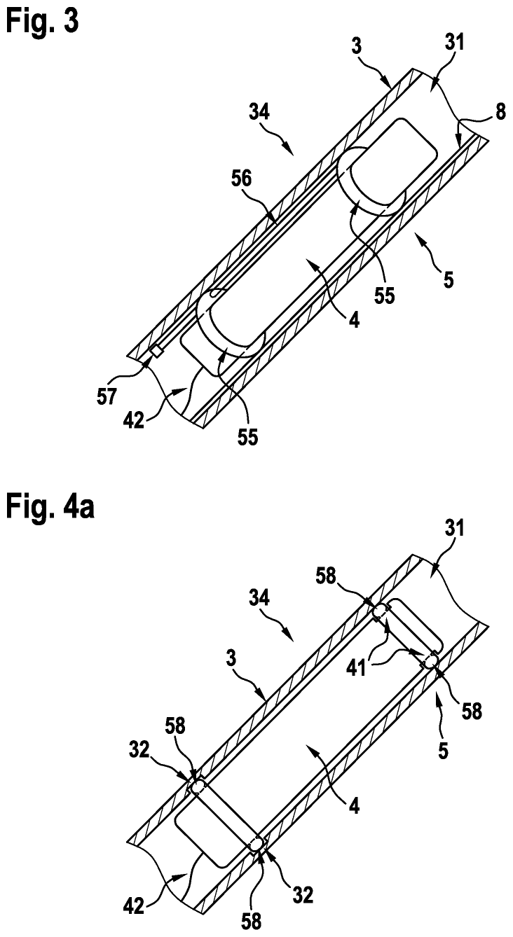

FIG. 3 shows a schematic sectional view according to a third exemplary embodiment of the electric bicycle with integrated electrical energy store 4 and holding device 5. In this embodiment, the holding device 5 comprises two toroidal hoses 55, which fix the electrical energy store 4 in the receiving portion 34 of the frame tube 3. The inner diameter of the toroidal hoses 55 corresponds approximately to the outer diameter of the electrical energy store 4, and the outer diameter of the toroidal hoses 55 corresponds approximately to the inner diameter of the frame tube 3.

The toroidal hoses 55 can be filled with a gas. A pressure in the interior of the toroidal hoses 55 results in a force, acting radially outwards and inwards from the toroidal hose 55 on the frame tube 3 and the electrical energy store 4, which fixes the electrical energy store 4 in the frame tube. The pressure may be increased or decreased by a valve 57. By lowering the pressure, the electrical energy store may be removed from the frame tube.

A compensation channel 56 connects the interiors of two or more toroidal hoses 55 and provides for uniform pressure in all toroidal hoses 55.

To install the electrical energy store 4, the toroidal hose 55 is placed around the electrical energy store 4 without pressure, then placed therewith in the interior 31 of the frame tube 3 and there provided with pressure via the valve 57 so that the electrical energy store is fixed in the frame tube 3.

Alternatively, the non-pressurized toroidal hose may be pre-installed in the receiving portion 34 of the frame tube 3. After placing the electrical energy store 4 in the toroidal hose 55 and increasing the pressure inside the toroidal hoses 55, these also then fix the electrical energy store 4.

In addition to the electrical energy store 4, the toroidal hose can also fix loose cables 8 or electrical conductors 42 in the frame tube 3.

To prevent breakdowns, the toroidal hoses 55 may be partially filled with a sealant or a temperature-resistant gel.

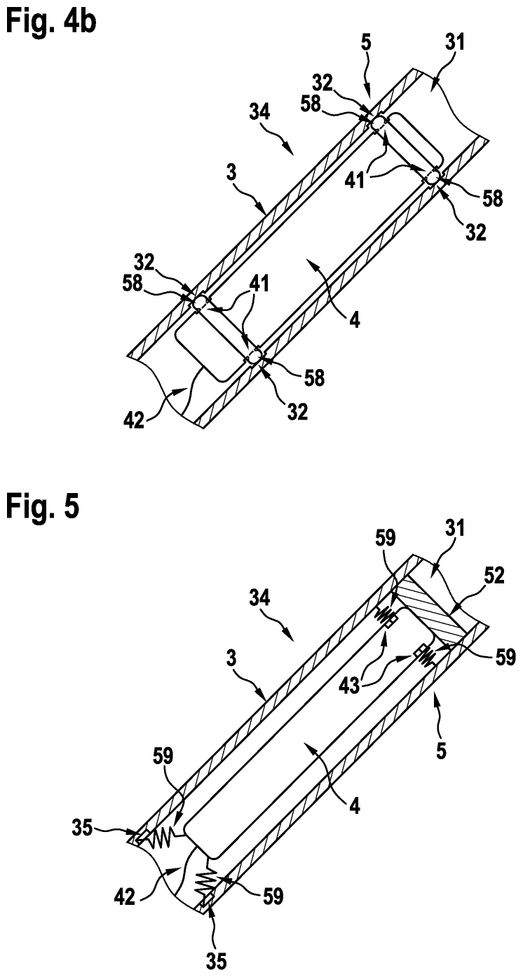

FIG. 4a shows a schematic sectional view of a fourth embodiment of the electric bicycle 1 longitudinally through the frame tube 3. This embodiment comprises a holding device 5 with elastomer rings 58. At least two elastomer rings 58 are fitted with an oversize fit between electrical energy store 4 and frame tube 3. Here, a cross-sectional diameter of the elastomer ring 58 is preferably 50% greater than the average distance between the electrical energy store 4 and the frame tube 3 at the seat of the elastomer ring 58.

Due to the oversize fit, they exert a radial force on the electrical energy store 4 and fix it.

To prevent the electrical energy store 4 from sliding axially, the elastomer rings 58 in FIG. 4a are fitted in a groove in the electrical energy store 41 or in a groove in the frame tube 32.

FIG. 4b shows one embodiment of the holding device 5 of FIG. 4a, wherein the elastomer ring 58 is fitted in a groove in the electrical energy store 41 and in a groove in the frame tube 32.

FIG. 5 schematically shows a fifth embodiment of the holding device 5, which uses spring elements 59 to fix the electrical energy store 4 in the frame tube 3. The spring element 59 is preferably from the group of leaf springs or poppet springs. Here, at at least one of the two ends, the spring element 59 is attached in a notch on the electrical energy store 43 and/or a notch on the frame tube 35.

The other end of the spring element 59 can be fixedly connected to the electrical energy store 4 or the frame tube 3. Either several individual spring elements 59 or a large spring element 59 comprising several individual springs are placed circumferentially around the electrical energy store.

By bending the spring elements 59 back, they can be removed from the notch, and the electrical energy store 4 can be removed from the frame tube 3.

The spring element 59 at one end of the electrical energy store 4 can be connected to an axial stop 52 at the other end of the electrical energy store 4, as shown schematically in FIG. 5.

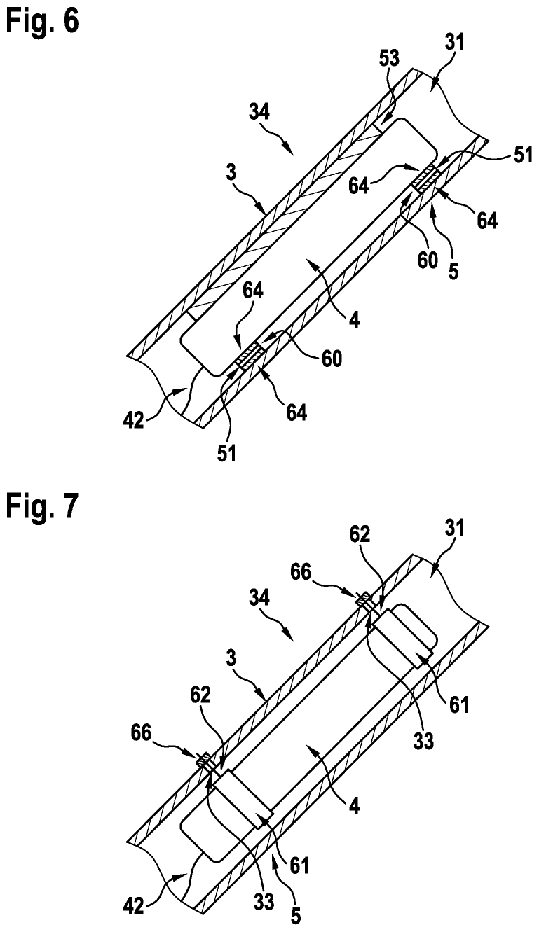

FIG. 6 schematically shows a sixth embodiment of the holding device 5, which uses flat adhesive elements 60 to fix the electrical energy store in the frame tube. An adhesive element 60 comprises an elastic element 51 which has an adhesive retaining surface 64 on the surface facing the electrical energy store 4 and the surface facing the frame tube 3. A material connection between the frame tube 3 and the electrical energy store 4 is produced via the adhesive element 60 made of the adhesive retaining surfaces 64 on the elastic element 51.

By inserting a strip between the elastic element 51 and the retaining surface 64, wherein a tab protrudes, the adhesive connection can be removed by pulling the tab, and the electrical energy store 4 can be removed from the frame tube 3. The adhesive elements 60 can be distributed circumferentially around the electrical energy store 4.

Alternatively, a longitudinal side of the electrical energy store 4, for example, may be fixed by a radial stop 53, and the opposite side may be fixed with adhesive elements 60.

FIG. 7 shows, in a schematic sectional view, a seventh embodiment of the electric bicycle 1 longitudinally through the frame tube 3. This embodiment comprises a holding device 5 with clamps 61. The clamps 61 or clips enclose the electrical energy store 4 and are connected to the frame tube 3 via a connecting means 62.

The clamps 61 can, for example, be closed via a screw or snap mechanism and can fix or also again release the electrical energy store 4.

The contact surface between clamp 61 and electrical energy store 4 may have an elastic material.

The connecting means 62 may be fixed, for example, through openings 33 in the frame tube 3 with nuts 66 via threads in the connecting means 62. Alternatively, other positive-, material-, or force-fit joining methods are also conceivable, such as welding or otherwise applying the connecting means 62 to the frame tube 3.

The clamp 61 can be connected to the electrical energy store 4 in advance and then inserted together with it into the frame tube 3. It is also possible to connect the clamp 61 to the frame tube 3 in advance via the connecting means 62 and then to insert the electrical energy store 4 into the frame tube 3 and fix it via the clamps 61.

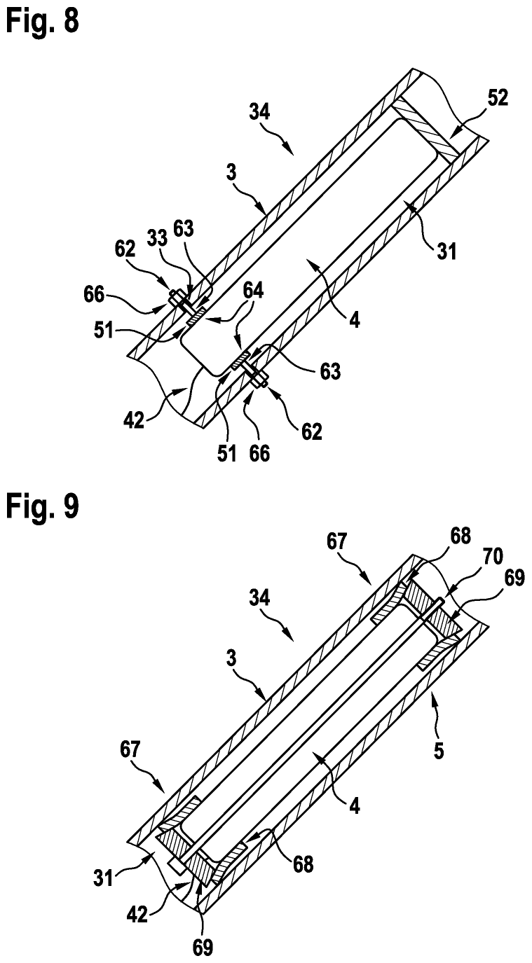

FIG. 8 schematically shows an eighth embodiment of the holding device 5, which uses at least three circumferentially-distributed retaining elements 63 to fix the electrical energy store 4 in the frame tube 3. The retaining element 63 preferably corresponds to an elastic element 51 with a retaining surface 64, which is directed towards the electrical energy store 4. The retaining element 63, via connecting means 62, which is arranged on the retaining element 63, is connected to the frame tube 3 and pressed against the electrical energy store. This radial force fixes the electrical energy store 4 in the frame tube 3.

For example, as shown schematically in FIG. 8, the connecting means 62 can be fixed and tightened through an opening 33 in the frame tube 3 and a screw connection. Alternatively, any other joining methods are conceivable for connecting the connecting means 62 to the frame tube 3 and clamping it against the electrical energy store 4.

The holding device 5, which comprises the aforementioned retaining elements 63, can also, as shown in FIG. 8, be combined with an axial stop 52 at an axial end of the electrical energy store 4 in order to fix it axially.

Axial 51 and/or radial stops 52 may further be combined with all other embodiments of a holding device 5 mentioned in this document.

FIG. 9 shows a schematic sectional view of a ninth embodiment of the electric bicycle 1 longitudinally through the frame tube 3. This embodiment comprises a holding device 5 with expansion element 67. This expansion element, in the embodiment depicted in FIG. 9, comprises an expansion sleeve 68, an expansion cone 69, and a screw 70. The expansion sleeve 68 is arranged at the axial end of the electrical energy store 4, between it and the frame tube 3. An axial force is exerted upon the expansion cone 69 via the screw 70 or an equivalent element, whereby the expansion cone 69 wedges with the expansion sleeve 68, radially expanding the expansion sleeve 68 and generating a radial holding force.

The expansion sleeve 68 is preferably made from an elastic material and/or has flexible structures that facilitate radial expansion of the expansion sleeve 68.

The electrical conductor 42 may be guided through a hole in the expansion cone.

The screw 70 preferably extends, as depicted in FIG. 9, from an expansion element 67 on one side of the electrical energy store 4 through it to an expansion element 67 on the other side of the electrical energy store 4. Here, one end of the screw 70 has a screw head and the other end a thread connected to an associated thread in the expansion cone 69 or to a nut 66 attached to the expansion cone 69.

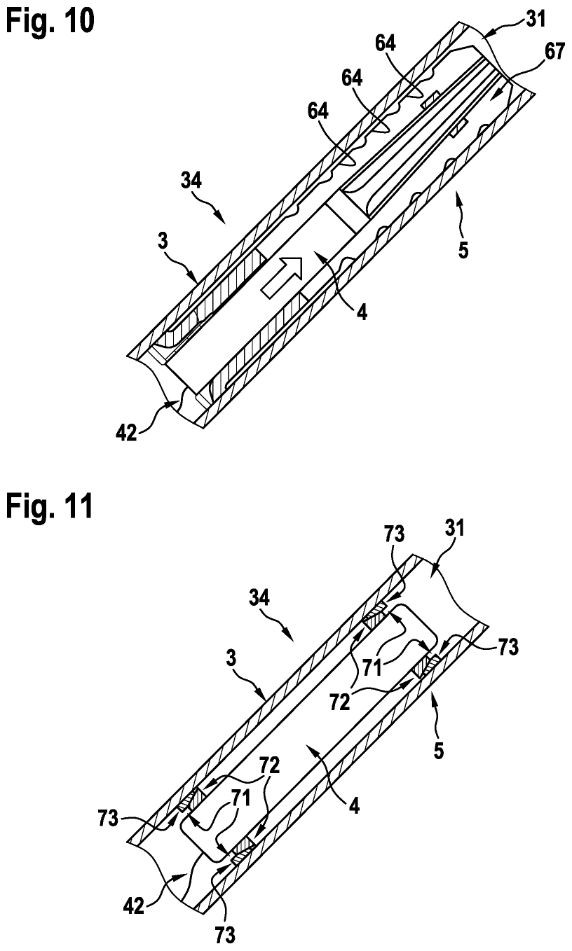

FIG. 10 schematically shows a tenth embodiment of the holding device 5, which uses a further embodiment of an expansion element 67 to fix the electrical energy store 4 in the frame tube 3. This expansion element 67 consists of an element which has a conical bore for receiving the electrical energy store 4. Due to the axial insertion of the electrical energy store into the frame tube 3 and the expansion element 67 placed therein, the expansion element 67 radially expands and, via retaining surfaces 64, exerts a radial force on the frame tube 3, which fixes the electrical energy store 4 therein.

The expansion element 67 is preferably axially fixed during the joining operation.

The one-piece expansion element 67 is preferably made of an elastic material and/or has flexible structures that facilitate radial expansion of the expansion element 67.

FIG. 11 shows a schematic sectional view of an eleventh embodiment of the electric bicycle 1 with integrated electrical energy store 4 and holding device 5. In this embodiment, the holding device 5 comprises a tapered press fit 71, which fixes the electrical energy store 4 in the receiving portion 34 of the frame tube 3. The electrical energy store 4 comprises an inner part 72 and the inner side of the frame tube 3 an outer part 73, which are arranged opposite one another. Here, the slope of the lateral surface is preferably the same for the inner and outer parts 72, 73 of the tapered press fit 71. Inner and outer parts 72, 73 can be clamped together during installation by a single axial force.

In another possible embodiment, inner and outer parts 72, 73 are axially clamped and secured together via a screw 70. The screw 70 passes through a bore in the inner and outer parts 72, 73 and exerts an axial force thereon.

The outer part 73 can be loosely or permanently connected to the frame tube 3. Preferably, the holding device has two tapered press fits 71, wherein one outer part 73 is permanently connected to the frame tube 3, and the other outer part 73 clamps the tapered press fit 71 by an axial force. The inner parts 72 are preferably permanently clamped to the electrical energy store 4.

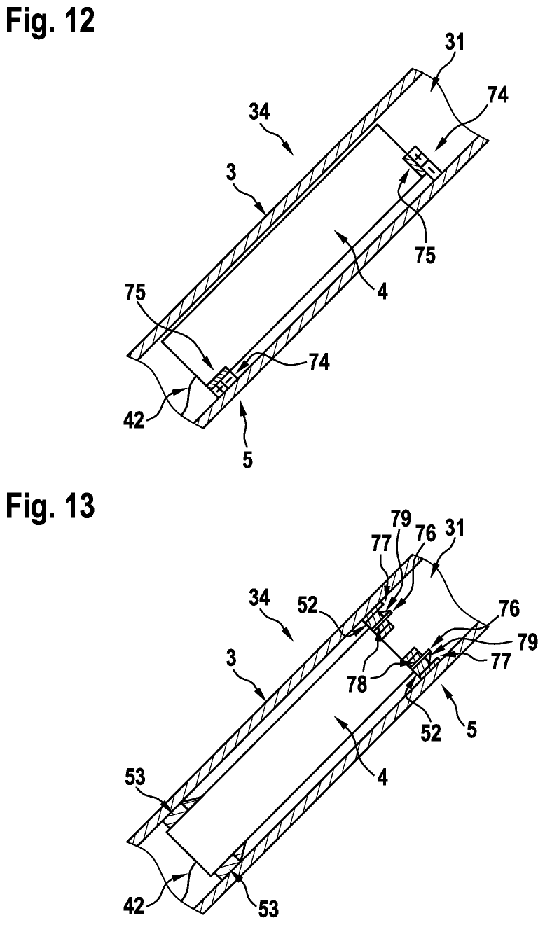

FIG. 12 schematically shows a twelfth embodiment of the holding device 5, which uses magnetism to fix the electrical energy store 4 in the frame tube 3. The holding device 5 comprises a magnetic portion 74—preferably comprising a permanent magnet—and an associated ferromagnetic element 75. The magnetic portion 74 generates a magnetic force that attracts the ferromagnetic element 75.

The magnetic portion 74 can be fixedly arranged on either the electrical energy store 4 or the frame tube 3. The ferromagnetic element 75 is fixedly arranged at the associated region of the opposite component. In the installed state, the ferromagnetic element 75 and the magnetic portion 74 abut one another and fix the electrical energy store 4 in the frame tube 3.

The at least one magnetic retaining element 5 is preferably attached to the longitudinal side of the electrical energy store 4, but can also be attached to an axial end or, in combination, to the longitudinal side and the axial end.

FIG. 13 schematically shows a thirteenth embodiment of the holding device 5, which uses snap hook 76 to fix the electrical energy store 4 in the frame tube 3. The snap hooks 76 are fixedly connected to the frame tube 3 or the electrical energy store 4 and engage in a fixing element 77, which, on the side opposite the snap hook 76, is attached to the frame tube 3 or the electrical energy store 4. The snap hook 76 comprises an elastic web 78 and a chamfer 79 at the axial end, to allow the snap hook to penetrate into the undercut of a fixing element 77. By bending the snap hook 76, it can be removed from the fixing element 77, whereby the electrical energy store 4 can be removed from the frame tube 3.

The web 78 of the snap hook 76 is preferably designed to be parallel to the longitudinal axis of the frame tube 3. By preloading the snap hooks 78, they can exert a radial force upon the electrical energy store 4. FIG. 13 shows an advantageous combination with a radial stop 53. Alternatively, the holding device 5 can also be combined with one of the aforementioned embodiments of a holding device 5.

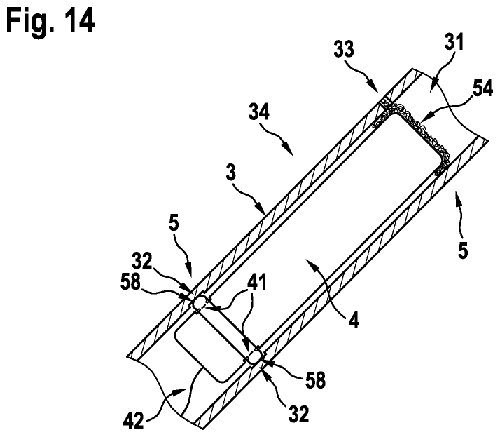

For example, FIG. 14 schematically shows a combination of two embodiments of the holding device 5 for fixing the electrical energy store 4 in the frame tube 3 of the electric bicycle 1. Here, one end of the electrical energy store 4 is fixed by hardenable foam 54 and the other end with an elastomer ring 58, which is fitted in a groove in the electrical energy store 41 and in the interior of the frame tube 32. This combination may be non-destructively removed, compared to holding device 5, described in the first exemplary embodiment, made of hardenable foam 54. By combining multiple embodiments of the holding device 5, the number of elements used in each embodiment may be reduced.

1. An electric bicycle comprising:
an electric drive;
at least one frame tube having an interior in which a receiving portion is arranged;
an electrical energy store arranged in the interior of the at least one frame tube and configured to be received by the receiving portion; and
a holding device configured to establish a connection between the electrical energy store and the frame tube and to fix the electrical energy store in the interior to the frame tube, the holding device having no electrical contacts,
wherein the holding device fixes the electrical energy store in the frame tube at least by a radial force and the holding device is connected to the electrical energy store without a screw connection.

2. The electric bicycle according to claim 1, wherein the electrical energy store does not have a housing.

3. The electric bicycle according to claim 1, wherein the holding device is connected to the frame tube without a screw connection.

4. The electric bicycle according to claim 1, wherein the holding device comprises an elastic element, which attenuates transmission of force between the frame tube and the electrical energy store and compensates for manufacturing tolerances.

5. The electric bicycle according to claim 1, wherein the holding device is configured to fix a cable that runs in the interior of the frame tube.

6. The electric bicycle according to claim 1, wherein the frame tube has an axial stop and/or radial stop.

7. The electric bicycle according to claim 1, wherein the holding device comprises hardenable foam filling a cavity between the electrical energy store and the frame tube.

8. The electric bicycle according to claim 1, wherein the holding device comprises a toroidal, pressurized hose, which is positioned radially between the electrical energy store and the frame tube to hold the electrical energy store in the frame tube.

9. The electric bicycle according to claim 1, wherein the holding device comprises an elastomer ring positioned in a groove in the interior of the frame tube and/or a groove of the electrical energy store and that fixes the electrical energy store.

10. The electric bicycle according to claim 1, wherein the holding device comprises a spring element arranged between electrical energy store and frame tube.

11. The electric bicycle according to claim 1, wherein the holding device comprises an adhesive element connecting the electrical energy store to the frame tube.

12. The electric bicycle according to claim 1, wherein the holding device comprises a clamp enclosing the electrical energy store and connecting the electrical energy store to the frame tube via a connecting arrangement, wherein the clamp is fixed from outside the frame tube.

13. The electric bicycle according to claim 1, wherein:
the holding device comprises at least three retaining elements radially distributed over a circumference of the electrical energy store, each of the three retaining elements having a first end with a retaining surface arranged on the electrical energy store that exerts a radially inwardly-directed holding force on the electrical energy store, and a second end arranged on the frame tube, and
the retaining element is fixed from outside the frame tube.

14. The electric bicycle according to claim 1, wherein the holding device comprises an expansion element.

15. The electric bicycle according to claim 1, wherein the holding device comprises a tapered press fit.

16. The electric bicycle according to claim 1, wherein the holding device comprises a magnetic portion that fixes the electrical energy store with a magnetic force to a ferromagnetic element in the frame tube.

17. The electric bicycle according to claim 1, wherein the holding device comprises a snap hook that fixes the electrical energy store.

18. The electric bicycle according to claim 1, wherein the holding device has different retaining elements.

19. The electric bicycle according to claim 1, further comprising an electrical conductor connecting the electrical energy store to the electrical drive.
